(19) United States
(12) Patent Application Publication
(10) Pub. No.: US 2014/0123802 A1
(43) Pub. Date: May 8, 2014

(54) ACCELERATOR PEDAL APPARATUS FOR VEHICLE

(71) Applicant: HYUNDAI MOTOR COMPANY, Seoul (KR)

(72) Inventors: Eun Sik KIM, Gyeonggi-do (KR); Yang Rae CHO, Gyeonggi-do (KR); Jeong Seon MIN, Gyeonggi-do (KR); Kwang Gi LEE, Gyeongsangbuk-do (KR)

(73) Assignee: HYUNDAI MOTOR COMPANY, Seoul (KR)

(21) Appl. No.: 13/797,085

(22) Filed: Mar. 12, 2013

(30) Foreign Application Priority Data
Nov. 8, 2012 (KR) 10-2012-0126283

(51) Int. Cl. G05G 1/30

(52) U.S. Cl. CPC G05G 1/30
USPC 74/513

(57) ABSTRACT

An accelerator pedal apparatus, in which pedal effort can be varied through length variation of a spring. Stroke of a pedal arm can be varied in accordance with inclination and body type of driver.

### CROSS-REFERENCE TO RELATED APPLICATION

This application claims under 35 U.S.C. §119(a) the benefit of Korean Patent Application No. 10-2012-0126283 filed on Nov. 8, 2012, the entire contents of which are incorporated herein by reference.

### BACKGROUND

(a) Technical Field

The present disclosure relates to an accelerator pedal apparatus for a vehicle, and more particularly, to an accelerator pedal apparatus for a vehicle in which pedal effort and a stroke of the pedal can be adjusted.

(b) Background Art

FIG. 1 is a perspective view illustrating an accelerator pedal apparatus for a vehicle of an organ type according to related art wherein it includes a pedal arm housing 1 that is fixed to a vehicle body panel at a lower part of a driver seat, a pedal arm 2 one end of which is coupled rotatably to the pedal arm housing 1, a pedal bracket 3 that is fixed to a floor panel at a lower part of the driver seat, and a pedal pad 4 one end of which is hinge-coupled rotatably to the pedal bracket 3 and which is ball-jointed to the pedal arm 2.

Here, a spring plate 5 is coupled to one end of the pedal arm 2 disposed inside the pedal arm housing 1 and one end of a spring 6 is supported on the spring plate 5 and the other end of the spring 6 is supported on the pedal arm housing 1.

Accordingly, in the accelerator pedal apparatus configured as described above according to the related art, the spring 6 is compressed elastically to provide pedal effort to the pedal pad 4 when the pedal arm 2 rotates with respect to the pedal arm housing 1 through a hinge shaft 7.

However, in the accelerator pedal apparatus according to the related art, since the spring 6 set in advance with an elastic coefficient to meet international safety regulations has to be used, the pedal effort cannot be adjusted unless the spring is replaced with new one.

Further, in the accelerator pedal apparatus according to a the related art, since the stroke of the pedal arm 2 is determined by contact with the pedal arm housing 1 when the pedal arm 2 rotates about the hinge shaft 7, a rotation angle of the pedal arm 2 in the accelerator pedal apparatus manufactured in accordance with various vehicles cannot be varied and thus there is no choice to vary the stroke of the pedal arm 2 when it is necessary to meet a driver preference.

The description provided above as related art to the present invention is only for helping understanding the background of the present invention and should not be construed as being included in the related art known by those skilled in the art.

### PATENT DOCUMENT

(Patent Document 1) KR 10-2010-0063453

### SUMMARY OF THE DISCLOSURE

The present invention has been made in an effort to solve the above-described problems associated with prior art, and it relates to providing an accelerator pedal apparatus for a vehicle through which pedal effort and stroke of the pedal can be adjusted in accordance with a driving condition, a driver condition and driving inclination of a driver, and which can be applied commonly to various kinds of vehicles.

Accordingly in this, the present invention provides an accelerator pedal apparatus for a vehicle including a pedal effort adjusting module provided with: a spring, one end of which is supported on one end of a pedal arm disposed inside a pedal arm housing; a spring fixing block provided to support the other end of the spring; a motor that is fixed to the inside of the pedal arm housing; and a power transmission mechanism that transmits power from the motor to the spring fixing block and moves the spring fixing block for a length of the spring to be varied.

The accelerator pedal apparatus for a vehicle may further include a stroke adjusting module provided with: a pedal arm stopper that is provided in the pedal arm housing to define a stroke of the pedal arm with contacting therewith when the pedal arm rotates about the hinge shaft; and a stopper operation mechanism that is provided in the pedal arm housing to contact the pedal arm stopper and varies a protruding length of the pedal arm stopper from the pedal arm housing.

The power transmission mechanism may include a plurality of worm gears and a plurality of worm wheel gears which couples the motor and the spring fixing block for transmitting power. A gear bolt on an outer peripheral surface of which a plurality of screw grooves are formed is formed integrally to be protruded, to a center of the worm gear to be coupled to the spring fixing block. A plurality of coupling grooves processed with screw grooves are formed on an inner surface of the spring fixing block to be screw-fastened to the gear bolt. The spring fixing block is moved linearly along the gear bolt when the worm gear rotates.

The stopper operation mechanism may include: a bolt housing that is fixed to the pedal arm housing; a screw bolt which is provided shaft-rotatably with respect to the bolt housing and on an outer peripheral surface of which a plurality of screw grooves are formed along a longitudinal direction; and a moving block that is screw-fastened to the screw bolt and contacts the pedal arm stopper, and varies a protruding length of the pedal arm stopper while being moving linearly alone the screw bolt when the screw bolt shaft-rotates.

A bottom surface of the pedal arm stopper and a upper surface of the moving block are formed with inclined surfaces having same inclination angles, respectively, to be in face contact with each other.

A coupling rod is provided integrally to the moving block and a magnet is coupled to one end of the coupling rod, and a location of the magnet is sensed by an accelerator position sensor when the moving block moves along the screw bolt.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view illustrating an accelerator pedal apparatus according to related art;

FIG. 2 is a perspective view illustrating an accelerator pedal apparatus provided with a pedal effort adjusting module and a stroke adjusting module according to the present invention;

FIG. 3 is a perspective view illustrating the inside of a pedal arm housing in the accelerator pedal apparatus as shown in FIG. 2:

FIGS. 4 and 5 are perspective views illustrating the pedal effort adjusting module according to the present invention, respectively;

FIG. 6 is a perspective view illustrating the stroke adjusting module in the accelerator pedal apparatus according to the present invention; and

FIGS. 7 and 8 are views illustrating operation of the stroke adjusting module according to the present invention.

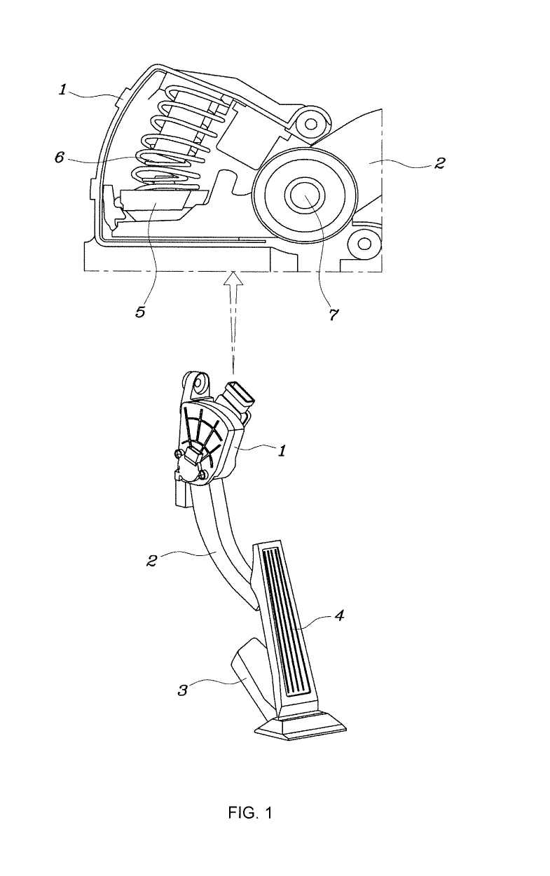

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter, an accelerator pedal apparatus for a vehicle according a preferred embodiment of the present invention will be described referring to the accompanying drawings.

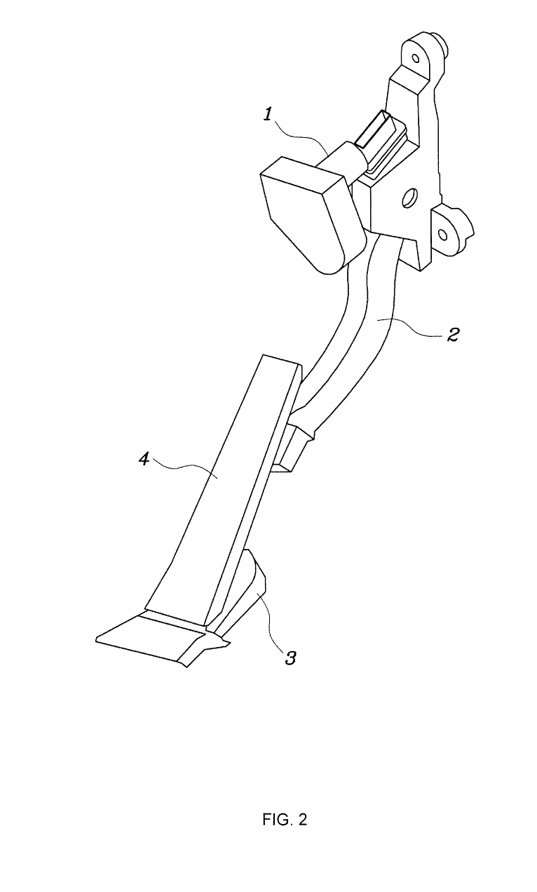

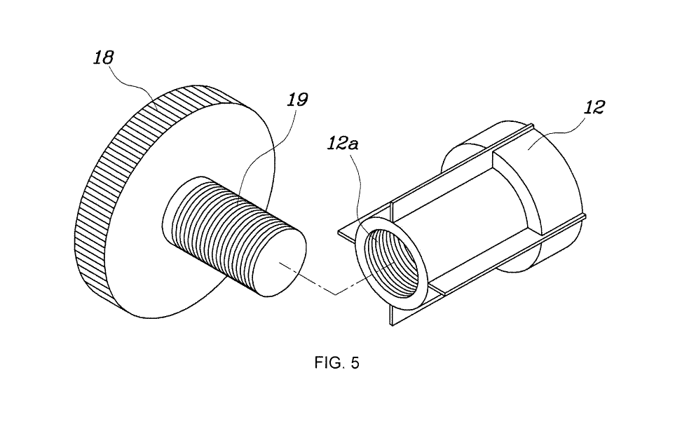

The accelerator pedal apparatus for a vehicle according to the present invention, as shown in FIGS. 2 to 8, may include a pedal arm housing 1 that is fixed to a vehicle body panel at a lower part of a driver seat, a pedal arm 2 one end of which is coupled rotatably to the pedal arm housing 1, a pedal bracket 3 that is fixed to a floor panel at a lower part of the driver seat, and a pedal pad 4 one end of which is hinge-coupled rotatably to the pedal bracket 3 and which is ball-jointed to the pedal arm 2.

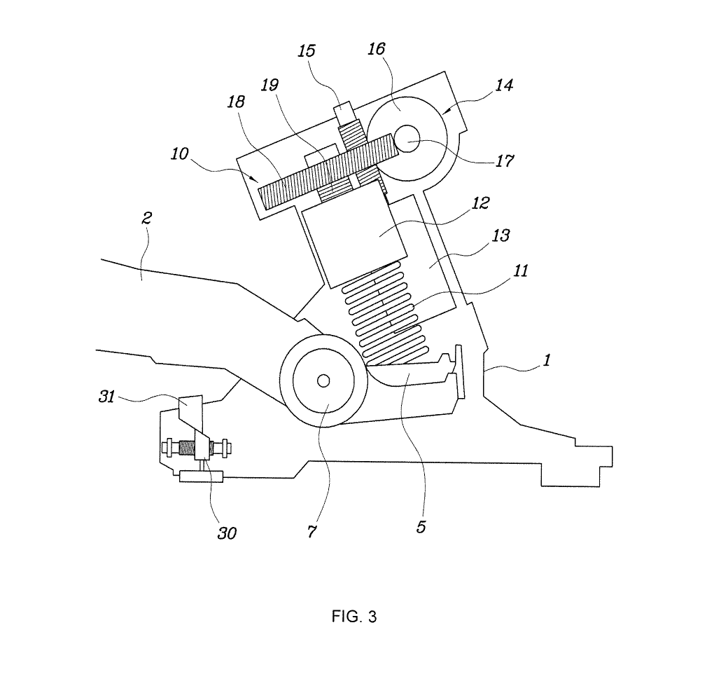

Meanwhile, a spring plate 5, (FIG. 3) is coupled to one end of the pedal arm 2 disposed inside the pedal arm housing 1 and the pedal arm 2 rotates with respect to the pedal arm housing 1 through a hinge shaft 7.

The accelerator pedal apparatus according to the present invention may include a pedal effort adjusting module 10 and a stroke adjusting module 30 wherein the pedal effort adjusting module 10 may include: a spring 11 one end of which is supported on one end of the pedal arm 2 disposed inside the pedal arm housing 1; a spring fixing block 12 that is arranged to support the other end of the spring 11; a motor 13 that is fixed to the pedal arm housing 1; and a power transmission mechanism 14 that transmits power from the motor 13 to the spring fixing block 12 and moves the spring fixing block 12 for a length of the spring 11 to be varied.

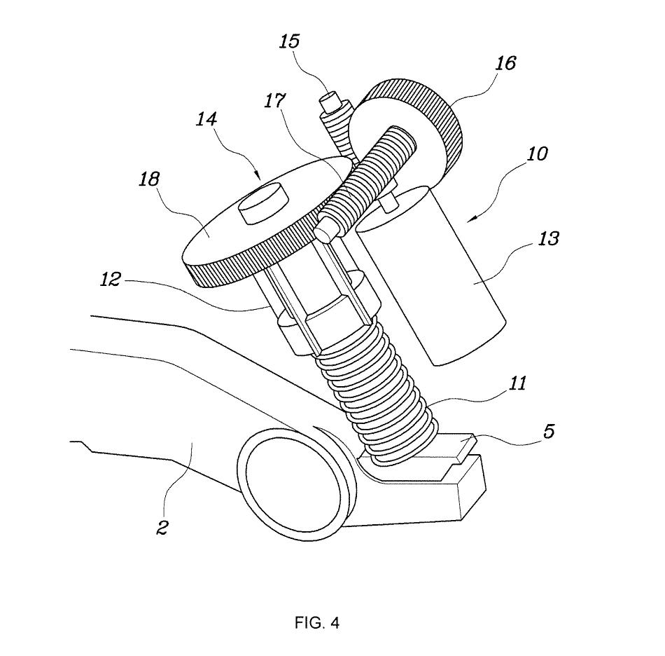

Here, the spring 11 may be arranged to be supported directly on one end of the pedal arm 2, or as shown in FIGS. 3 and 4, it may be arranged such that the spring plate 5 is coupled to one end of the pedal arm 2 disposed inside the pedal arm housing 1 and a lower end of the spring 11 is supported on the spring plate 5.

Accordingly, when the pedal arm 2 rotates about the hinge shaft 7, the spring 11 may be compressed elastically between the spring plate 5 and the spring fixing block 12 and a pedal effort may be provided to the pedal pad 4 through the pedal arm 2 during the elastic compression of the spring.

The power transmission mechanism 14 may be arranged to couple the motor 13 and the spring fixing block 12 to transmit power from the motor 13 to the spring fixing block 12. The mechanism 14 it may include a first worm gear 15 coupled integrally to a shaft of the motor 13, a first worm wheel gear 16 that is meshed with the first worm gear 15 to be rotated, a second worm gear 17 coupled integrally to a center of the first worm wheel gear 16, a second worm wheel gear that is meshed with the second worm gear 17 to be rotated, and a gear ball 19 which protrudes integrally from a center of the second worm wheel gear 16 and on an outer peripheral surface of which a plurality of screw grooves are formed.

Furthermore, a plurality of coupling grooves 12a processed with screw grooves may be formed on an inner peripheral surface of the spring fixing block 12, into which a gear bolt 19 is screw-fastened. Wherein when the second worm wheel gear 18 rotates, the spring fixing block 12 is moved linearly along the gear bolt 19 so that a length of the spring 11 can be varied by a movement of the spring fixing block 12 to vary pedal effort of the accelerator pedal.

The operation of the motor 13 may be controlled by a controller (not shown) in accordance with a driving condition, a driver condition and driving inclination, etc.

Meanwhile, the stroke adjusting module 30 may include a pedal arm stopper 31 that is provided in the pedal arm housing 1 to define a stroke of the pedal arm 2 with contacting therewith when the pedal arm rotates around the hinge shaft 7, and a stopper operation mechanism 32 that is provided in the pedal arm housing 1 to contact the pedal arm stopper 31 for varying a protruding length of the pedal arm stopper 31 which protrudes from the pedal arm housing 1.

The stopper operation mechanism 31 may include: a bolt housing 33 that is fixed to the pedal arm housing 1; a screw bolt 35 both ends of which are provided shaft-rotatably to the bolt housing 33 through the bearings 34 and on an outer peripheral surface of which a plurality of screw grooves are formed along a longitudinal direction; and a moving block 36 that is provided to be screw-fastened to the screw bolt 35 and contact the pedal arm stopper 31. Block 36 moves linearly along the screw bolt 35 when the screw bolt 35 shaft-rotates, to vary a protruding length of the pedal arm stopper 31 (the protruding length of the pedal arm stopper protruding from the pedal arm housing).

Here, a bottom surface of the pedal arm stopper 31 and a upper surface of the moving block 36 may be formed with inclined surfaces 31a, 36a having the same inclination angles, respectively, to be in face contact with each other.

The stroke adjusting module 30 may be operated passively in accordance with a user's necessity and to this end an instrument groove 35a of a cross type or a line type may be formed on one face of the screw bolt 35.

A coupling rod 37 may be provided integrally on the moving block 36 and a magnet 38 may be coupled to one end of the coupling rod 37. An accelerator position sensor senses a location of the magnet 38 when the moving block 36 is moved along the screw bolt 35, to vary a stoke range of an pedal operation.

Hereinafter, an operation of an accelerator pedal apparatus according to the present invention will be described.

Firstly, an adjusting of a pedal effort of an accelerator pedal will be described.

The motor 13 is operated with a control by a controller and power from the motor 13 is transmitted to the spring fixing block 12 through the worm gears 15, 17, the worm wheel gears 16, 18, and the gear bolt 19, and then the spring fixing block 12 is raised or lowered along the gear bolt 19 from the state shown in FIG. 3.

When the spring block 19 is raised along the bear bolt 19 (to a receding direction from the spring plate), the spring 11 is varied by elastic recovery force such that its entire length becomes longer and at this time a spring force applying to the pedal arm 2 is reduced and thus the pedal effort of the accelerator pedal is decreased.

On the contrary, when the spring block 12 is lowered along the gear bolt 19 (to an approaching direction to the spring plate), the spring 11 is compressed for its entire length to become shorter and at this time a spring force applying to the pedal arm 2 is increased and thus the pedal effort of the accelerator pedal is increased.

The motor 13 may be operated automatically with a control by a controller (not shown) wherein, as an example, it may be operated to reduce fatigue in accordance with an operation of the accelerator pedal by adjusting the pedal effort to be decreased while a vehicle drives at a low speed (city driving), or to reduce ankle fatigue by adjusting the pedal effort to be increased and helping the pedal to be supported constantly while a vehicle drives at a high speed (expressway driving).

Further, the pedal effort may be decreased on an ascending road to increase a pedal operation amount and be increased on a descending road to decrease the pedal operation amount.

Further, the pedal effort may be increased for safety while a vehicle drives at an over speed or on a safety mode, and further the pedal effort may be adjusted properly in considering of age, sex and condition of a driver.

Next, an adjusting of a stroke of the accelerator pedal will be described.

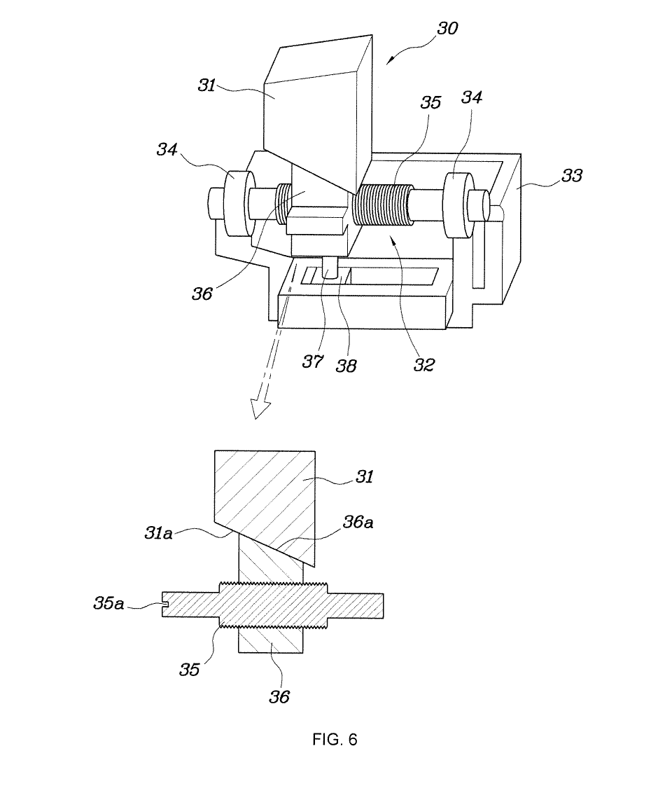

When an operator rotates directly the screw bolt 35 using an instrument, etc., the moving block 36 is moved rightward or leftward along a longitudinal direction of the screw bolt 35 from the state shown in FIG. 6.

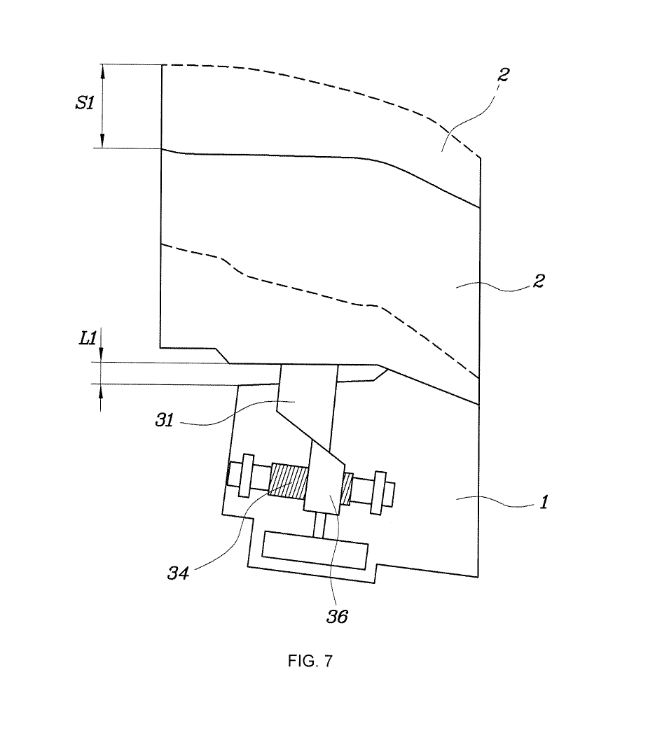

When the moving block 36 is moved rightward along the screw bolt 35, as shown in FIG. 7, a protruded length L1 of the pedal arm stopper 31 from the pedal arm housing 1 becomes longer and as a result a stroke S1 of the pedal arm 2 is decreased.

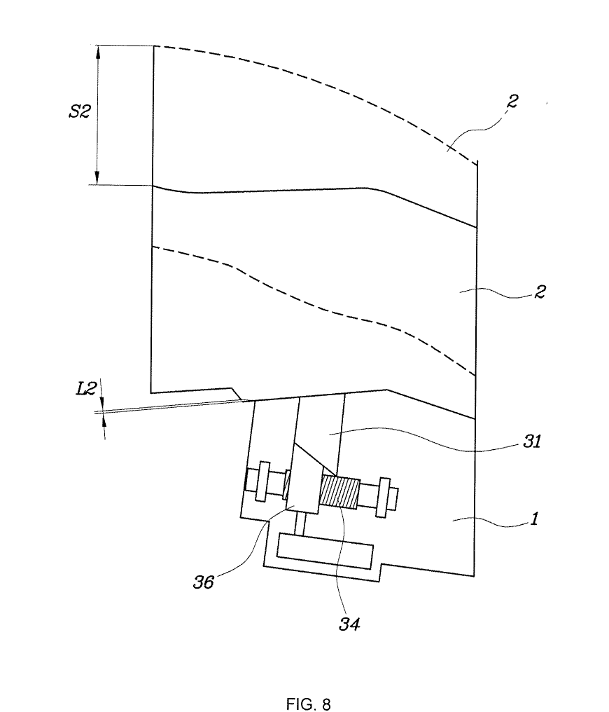

On the contrary, when the moving block 36 is moved leftward along the screw bolt 35, as shown in FIG. 8, a protruded length L2 of the pedal arm stopper 31 from the pedal arm housing 1 becomes shorter and as a result a stroke S2 of the pedal arm 2 is increased.

The stroke of the pedal may be varied by operating manually and directly the screw bolt 35 in accordance with an inclination and a body type condition of a driver.

According to the accelerator pedal apparatus of the present invention as described above, the length of the spring 11 can be varied by movement of the spring fixing block 12 in accordance with operation of the motor 13 without replacing separately other components. As a result, pedal effort can be varied easily, if necessary, to meet fully the safety regulations with respect to the pedal effort of the accelerator pedal regardless of kinds of vehicles.

Further, the stroke of the pedal arm 2 can be varied easily by adjusting the screw bolt 35 in accordance with an inclination and a body type condition, and thus commerciality of a product can be improved greatly by improving operation feel and driving quality, and reducing driving fatigue.

Further, the accelerator pedal apparatus cab be applied commonly to various kinds of vehicles which have different operation time moment of the accelerator pedal in accordance with engine specifications.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. An accelerator pedal apparatus for a vehicle comprising a pedal effort adjusting module comprising:
a spring one end, of which is supported on one end of a pedal arm disposed inside a pedal arm housing;
a spring fixing block provided to support the other end of the spring;
a motor that is fixed to the inside of the pedal arm housing; and
a power transmission mechanism that transmits power from the motor to the spring fixing block and moves the spring fixing block for a length of the spring to be varied.

2. The accelerator pedal apparatus for a vehicle according to claim 1, further comprising a stroke adjusting module comprising:
a pedal arm stopper that is provided in the pedal arm housing to define a stroke of the pedal arm with contact therewith when the pedal arm rotates around the hinge shaft; and
a stopper operation mechanism that is provided in the pedal arm housing to contact the pedal arm stopper and varies a protruding length of the pedal arm stopper from the pedal arm housing.

3. The accelerator pedal apparatus for a vehicle according to claim 1, wherein the power transmission mechanism comprises a plurality of worm gears and a plurality of worm wheel gears which couple the motor and the spring fixing block for transmitting power wherein a gear bolt on an outer peripheral surface of which a plurality of screw grooves are formed is formed integrally to be protruded, to a center of the worm gear to be coupled to the spring fixing block, a plurality of coupling grooves processed with screw grooves are formed on an inner surface of the spring fixing block to be screw-fastened to the gear bolt, and the spring fixing block is moved linearly along the gear bolt when the worm gear rotates.

4. The accelerator pedal apparatus for a vehicle according to claim 2, wherein the stopper operation mechanism comprises:
a bolt housing that is fixed to the pedal arm housing;
a screw bolt which is provided shaft-rotatably with respect to the bolt housing and on an outer peripheral surface of which a plurality of screw grooves are formed along a longitudinal direction; and
a moving block that is screw-fastened to the screw bolt and contacts the pedal arm stopper, and varies a protruding length of the pedal arm stopper while being moved linearly along the screw bolt when the screw bolt shaft-rotates.

5. The accelerator pedal apparatus for a vehicle according to claim 4, wherein a bottom surface of the pedal arm stopper and a upper surface of the moving block are formed with inclined surfaces having the same inclination angles, respectively, to be in face contact with each other.

6. The accelerator pedal apparatus for a vehicle according to claim 4, wherein a coupling rod is provided integrally to the moving block and a magnet is coupled to one end of the coupling rod, and a location of the magnet is sensed by an accelerator position sensor when the moving block is moved along the screw bolt.
